(19) United States
(12) Patent Application Publication
(10) Pub. No.: US 2016/0123546 A1
(43) Pub. Date: May 5, 2016

(54) LED Projector Capable of Emitting Light Spherically in 180°

(71) Applicant: NINGBO GEMAY INDUSTRY CO., LTD, Ningbo (CN)

(72) Inventors: Jining HU, Jinhua (CN); Bing HE, Jinhua (CN)

(73) Assignee: NINGBO GEMAY INDUSTRY CO., LTD

(21) Appl. No.: 14/570,730

(22) Filed: Dec. 15, 2014

(30) Foreign Application Priority Data
Oct. 29, 2014 (CN) 201420632320.4

(51) Int. Cl. F21S 8/00; F21V 5/04; F21V 7/00; F21V 23/00; F21V 17/10; F21V 31/00; F21V 29/77; F21V 21/30; F21V 1/04; F21V 7/04

(52) U.S. Cl. CPC F21S 8/033; F21V 1/04; F21V 5/046; F21V 7/0058; F21V 7/045; F21V 17/102; F21V 31/005; F21V 29/773; F21V 21/30; F21V 23/009; F21Y 2101/02

(57) ABSTRACT

An LED projector for emitting light spherically in 180° includes a driving power supply; a projector body; a lamp seat, with three slanted protruding surfaces, being placed inside the projector body, the three slanted protruding surfaces being distributed circularly with a first angle of 120° between any two slanted protruding surfaces; three LED lamps connected to the lamp seat, one LED lamp on each slanted protruding surface; a reflector plate, with a protrusion element for receiving the lamp seat, attached to the projector body, the protrusion element having three projection holes for receiving the LED lamps; a spherical transparent lampshade for covering projector body; and a lampshade frame. The LED projector has a simple and rational configuration with easy assembly, and has large range of irradiation, good light condensation effect and balanced light.

### RELATE APPLICATIONS

This application claims the benefit of Chinese Invention Application 201420632320.4, filed on Oct. 29, 2014, the specification of which is incorporated herein by this reference.

### FIELD OF THE INVENTION

The present invention relates to the technical field of semiconductor illumination, and particularly to an LED projector, for emitting light spherically in 180°.

### DESCRIPTION OF THE PRIOR ART

As a new generation of solid-state lighting, LEDs have the characteristics of low heat, high lighting efficiency, long service life and the like. With the continuous breakthrough of the LED technology, particularly with the successful development of high-power and high-efficiency LEDs, LEDs have been widely applied in the field of projectors in addition to the common lighting fixtures. LED projectors are mainly applied in building wall lighting, indoor local lighting, lighting of outer walls of historical building groups, tree and flower landscape lighting, billboard lighting, atmospheric lighting for bars, ballrooms and other entertainment venues, site construction and maintenance lighting, lighting for work and the like. For the existing single-lamp projectors, due to the unidirectional LED light emitting, such LED projectors when turned on have a maximum light emitting angle of 120° both in the longitudinal and horizontal directions, and are unable to provide a larger angle; meanwhile, the light emitting intensity in the front of an LED projector is higher than that on the periphery, with some regions irradiated by very little light and some regions even irradiated by no light, so that there will be dark regions when large-angle lighting is required. Thus, the characteristics of this structure, i.e., monotonic light emitting angle and non-uniform light emitting effect, directly influence the popularization and application of this product. Therefore, many manufacturers and people of insight have made efforts in the developments and studies. However, no ideal products have been found in the market.

### SUMMARY OF THE INVENTION

It is the object of the present invention to provide an LED projector for emitting light spherically in 180°, with simple and rational structure, convenient installation and use, large range of irradiation, balanced light and good lighting effect.

For achieving the above stated object, LED projector, for emitting light spherically in 180°, comprises: a driving power supply; a projector body attached to the driving power supply; a lamp seat, with three slanted protruding surfaces, being placed inside the projector body, the three slanted protruding surfaces being distributed circularly with a first angle of 120° between any two slanted protruding surfaces, a second angle, defined by a perpendicular line to any of the three slanted protruding surfaces and a perpendicular line to the lamp seat, being between 30° and 70°; three LED lamps connected to the lamp seat, one LED lamp on each slanted protruding surface; a reflector plate, with a protrusion element for receiving the lamp seat, attached to the projector body, the protrusion element having three projection holes for receiving the LED lamps; a spherical transparent lampshade for covering projector body; and a lampshade frame, for holding the spherical transparent lampshade, mounted on the projector body.

Preferably, the second angle β is 50°.

Preferably, the LED projector further comprises a sealing ring, the transparent lampshade is secured to the projector body by the lampshade frame, and the sealing ring is placed between the transparent lampshade and the projector body, thereby forming a waterproof and dustproof sealed structure.

Preferably, a fixed support assembly is movably attached to the projector body for adjusting an illumination angle.

Preferably, the projector body has a back side and the projector body further comprising a plurality of cooling blades longitudinally attached to the back side of the projector body.

Compared with the prior art, the invention has following advantages:

1. Since the three LED lamps are respectively connected to the corresponding slanted protruding surface of the lamp seat, in aid of the control to the second angle β defined by a perpendicular line to any of the three slanted protruding surfaces and a perpendicular line to the lamp seat, and due to the first angle of 120° between any two of the three high-power LED lamps, the lighting fixtures spherically emit light in 180°, with advantages of large lighting range, good lighting effect and balanced light, so that dark regions are avoided.

2. Since a waterproof and dustproof sealed structure is formed between the transparent lampshade and the projector body, the projector may be used in severe places and environments.

3. Since a plurality of cooling blades are longitudinally attached to the back side of the projector body, air may flow up and down between the cooling blades, thereby quickening the heat exchange rate and improving the heat dissipation efficiency.

4. The angle of projection of the projector may be adjusted by the fixed support assembly capable of adjusting the illumination angle.

### BRIEF DESCRIPTION OF THE DRAWINGS

FIG. 1 is a perspective view of an LED projector in accordance with an embodiment of the present invention;

FIG. 2 is a front view of the LED projector in accordance with the embodiment of the present invention;

FIG. 3 is a sectional view of the LED projector in accordance with the embodiment of the present invention;

FIG. 4 is an exploded perspective view of the LED projector in accordance with the embodiment of the present invention.

### DETAILED DESCRIPTION OF THE PREFERRED EMBODIMENT

To enable a further understanding of the innovative and technological content of the invention herein refer to the detailed description of the invention and the accompanying drawings below:

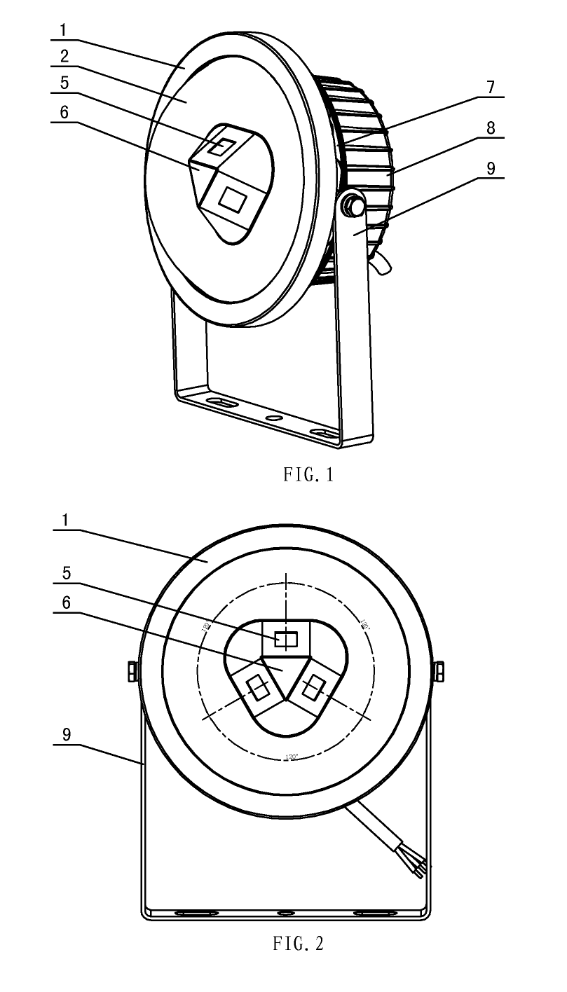

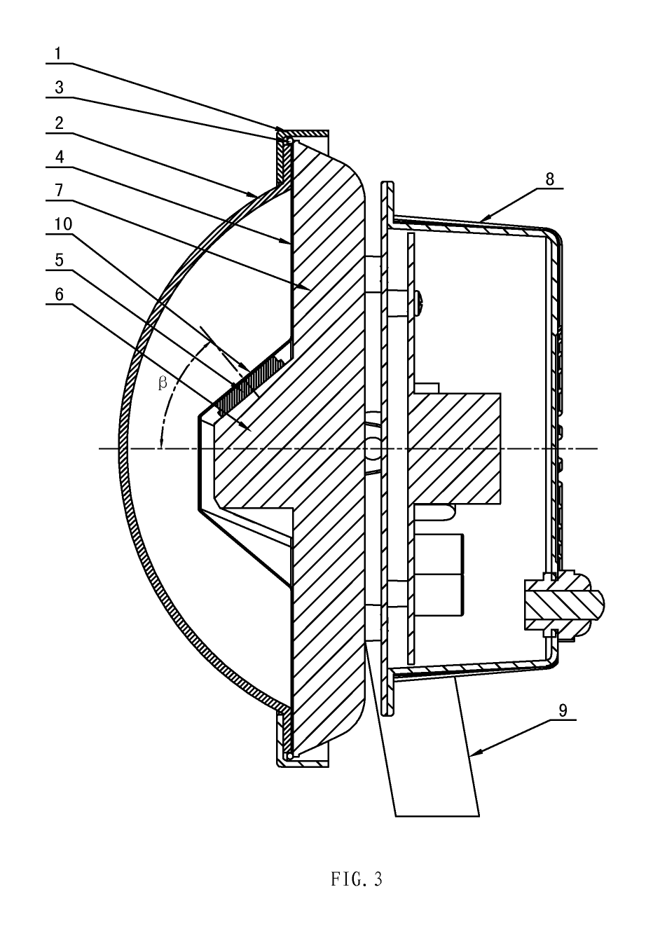

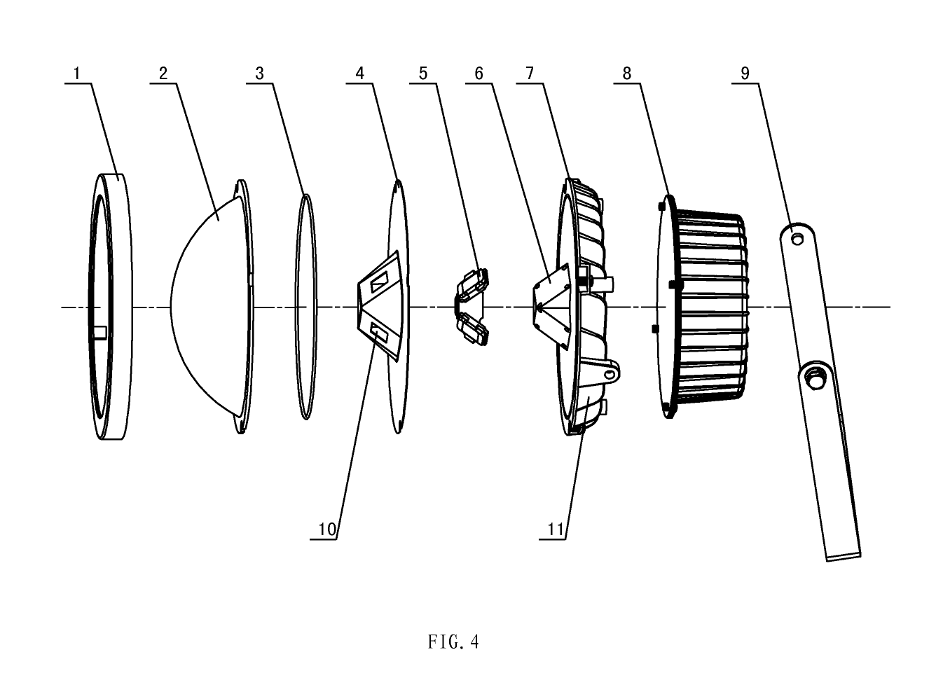

As shown in FIGS. 1-4, the LED projector comprises a lampshade frame 1, a transparent lampshade 2, a reflector plate 4, three LED lamps 5, a lamp seat 6, a projector body 7 and a driving power supply 8.

The lampshade 2 is made of transparent material which may be transparent glass or transparent plastics, etc. The lampshade 2 is hemispherical and fixed on the front surface of the projector body 7 by pressing the circumferential edge of the lampshade 2 by the lampshade frame 1.

The projector body 7 is attached to the back of the driving power supply 8.

The lamp seat 6, with three slanted protruding surfaces, is placed inside the projector body 7, the three slanted protruding surfaces is distributed circularly with a first angle of 120° between any two slanted protruding surfaces, a second angle β, defined by a perpendicular line to any of the three slanted protruding surfaces and a perpendicular line to the lamp seat, is between 30° and 70°, possibly 30°, 40°, 50° or 70°. In this embodiment, the second angle β is 50°. The LED lamps 5 are respectively fixed on the corresponding inclined plane.

The reflector plate 4 is attached to the front surface of the projector body 7. Specifically, the edge of the reflector plate 4 is pressed between the edge of the lampshade 2 and the front surface of the projector body 7. The reflector plate 4 has a protrusion element for receiving the lamp seat 6, and the protrusion element has three projection holes 10 for receiving the LED lamps.

The first angle between any two of the three high-power LED lamps 5 is 120°, and the lighting fixtures spherically emit light in 180°, with advantages of large lighting range, good lighting effect and balanced light, so that dark regions are avoided.

In order to ensure that the projector may be used in severe places and environments, a sealing ring 3 is placed between the transparent lampshade 2 and the projector body 7, thereby forming a waterproof and dustproof sealed structure.

In order to adjust the illumination angle of the projector, a fixed support assembly 9 movably attached to the projector body for adjusting an illumination angle.

In order to improve the heat dissipation effect, the projector body 7 has a back side and the projector body further comprises a plurality of cooling blades 11 longitudinally attached to the back side of the projector body 7.

The foregoing description merely shows the embodiments of the present invention, and is not intended to limit the patent scope of the present invention. A number of simple deductions and replacements made without departing from the concept of the present invention shall fall into the protection scope of the present invention.

1. An LED projector, capable of emitting light in 180°, comprising,
a projector body having a front surface, a back, and a center;
a power supply connected to the projector body;
a plurality of integrated LED lamps;
a reflector cup disposed on the front surface;
a lampshade; and
a lampshade frame;
a lamp seat, having a pair of symmetrical inclined planes, each inclined plane having a center line, is disposed in the center of the projector body, an angle between the vertical center lines of the two inclined planes is between 30° and 90°; and
two integrated LED lamps, each LED lamp being fixed on an inclined plane of the lamp seat,
wherein the reflector cup has a bulge fitted with the lamp seat, and the bulge has two light projection holes for receiving the integrated LED lamps.

2. The LED projector of claim 1, wherein the two inclined planes of the lamp seat are arranged left and right of the projector body, or arranged up and down of the projector body.

3. The LED projector of claim 1, wherein the angle between the vertical center lines of the two inclined planes is 60°.

4. The LED projector of claim 1, wherein the lampshade is fixed on the projector body by pressing the lampshade frame toward the projector body, and a sealing ring is provided between the lampshade and the projector body to form a waterproof and dustproof sealed structure.

5. The LED projector of claim 4, further comprising a plurality of longitudinal cooling blades attached to the back of the projector body.

6. The LED projector of claim 5, further comprising a mounting support assembly movably connected to the projector body for adjusting an illumination angle.

7. The LED projector of claim 6, wherein the power supply is provided with a waterproof connector connected to a power line.
